(19) United States
(12) Patent Application Publication
(10) Pub. No.: US 2019/0022592 A1
(43) Pub. Date: Jan. 24, 2019

(54) HOLLOW FIBER MEMBRANE MODULE

(71) Applicant: Saudi Arabian Oil Company, Dhahran (SA)

(72) Inventor: Seung-Hak Choi, Dhahran (SA)

(21) Appl. No.: 15/652,966

(22) Filed: Jul. 18, 2017

(51) Int. Cl. B01D 63/02; B01D 53/22

(52) U.S. Cl. CPC B01D 63/02; B01D 2053/224; B01D 2313/14; B01D 53/228

(57) ABSTRACT

A hollow fiber membrane module including a housing and a fiber bundle contained in the housing and arranged along a length of the housing. The fiber bundle includes hollow fiber membranes and elongated spacers positioned among and in direct contact with the hollow fiber membranes. An outer surface along a length of each elongated spacer defines openings or protrusions or curved, discontinuous, or nonlinear portions. Each hollow fiber membrane is cylindrical and defines an opening along its length. The housing defines an inlet for a feed mixture including a gas, a vapor, or both; a first outlet for a permeate of the hollow fiber membranes; and a second outlet for a retentate of the hollow fiber membranes.

### TECHNICAL FIELD

This invention relates to a hollow fiber membrane module including spacers for enhancing the mass-transfer rate of gas and vapor in the module.

### BACKGROUND

Membrane processes for separating gas and/or vapor (that is, gas, vapor, or a combination of gas and vapor) in a feed mixture take advantage of chemical and physical interaction (or affinity) between the membrane and components in the feed mixture. In a typical membrane process, a feed mixture contacts a feed side of a membrane and selectively penetrates the membrane based at least in part on the different solubilities of the gas and/or vapor components into the polymer and diffusivity differences of the gas and/or vapor components through the membrane. The permeate, or components of the feed mixture that pass through the membrane, are removed from the permeate side of the membrane.

For industrial applications, large membrane areas are achieved by packing membranes into modules. Hollow fiber membrane modules are among the most widely used membrane module types in industrial applications. In hollow fiber membrane modules, the feed can be introduced inside the fiber (called “inside-out”) or outside the fiber (called “outside-in”). FIG. 1 is a cross-sectional view of an example of “inside-out” hollow fiber membrane module 100 with housing 102. A fiber bundle containing hollow fibers 104 is contained in housing 102 and secured to tube sheets 106. A feed mixture is provided to hollow fiber membrane module 100 via port 108. Permeate exits hollow fiber membrane module 100 via ports 110, and retentate exits hollow fiber membrane module 100 via port 112. FIG. 2 is a cross-sectional view of an example of an “outside-in” hollow fiber membrane module 200 with housing 202. A fiber bundle containing hollow fibers 204 are contained in housing 202 and secured to tube sheets 206. A feed mixture is provided to hollow fiber membrane module 200 via port 208. Permeate exits hollow fiber membrane module 200 via port 210, and retentate exits hollow fiber membrane module 200 via port 212.

A baseline for process performance in hollow fiber membrane modules can be determined by assuming the fibers are uniform (identical inner and outer radii and permeances) and uniformly spaced. Additionally, baseline performance predictions assume the fluid distribution is uniform, that is, the flow rate inside and outside each fiber in the fiber bundle is identical. The performance of this “ideal” device can be determined by analyzing the performance of a single fiber. However, actual module performance in terms of flux and recovery is much lower than ideal performance. For instance, one disadvantage of the “outside-in” configuration is that “channeling” may occur. This means that the feed has a tendency to flow along a fixed path, thereby reducing the effective membrane surface area. When the feed mixture is introduced inside the hollow fiber, the concentration build-up (concentration polarization) of permeate on outside of the fiber can result in poor module performance.

### SUMMARY

In a first general aspect, a hollow fiber membrane module includes a housing and a fiber bundle contained in the housing and arranged along a length of the housing. The fiber bundle includes hollow fiber membranes and elongated spacers positioned among and in direct contact with the hollow fiber membranes. An outer surface along a length of each elongated spacer defines openings or protrusions or curved, discontinuous, or nonlinear portions. Each hollow fiber membrane is cylindrical and defines an opening along its length. The housing defines an inlet for a feed mixture including a gas, a vapor, or both; a first outlet for a permeate of the hollow fiber membranes; and a second outlet for a retentate of the hollow fiber membranes.

Implementations of the first general aspect may include one or more of the following features.

An outer diameter of the elongated spacers is 20% to 200% of the outer diameter of the hollow fiber membranes. The hollow fiber membranes and the elongated spacers occupy 40% to 60% of the interior volume of the housing, and the elongated spacers occupy 5% to 50% of the total volume occupied by the hollow fiber membranes.

Some elongated spacers are in the form of lumped fibers or threads.

Some elongated spacers define an opening along the length of the spacer. Some elongated spacers have a solid core.

Some elongated spacers include a braided shell formed of a mesh defining openings. The braided shell may be hollow. The elongated spacer may further include a core positioned within the braided shell. The core may be solid or hollow (tubular).

Some elongated spacers include a multiplicity of geometrical shapes coupled together.

Some elongated spacers include a hollow wavy fiber or a solid wavy thread.

Some elongated spacers include a core and a winding wound about the core from a first end of the core to a second end of the core. The core may be a solid core or a hollow (tubular) core. The winding may be formed of metal, ceramic, glass, polymer, or a combination thereof. The elongated spacers may be formed of metal, ceramic, glass, polymer, or a combination thereof.

Advantages of embodiments described herein include the use of spacers to enhance the mass-transfer rate of a feed and permeate mixture including gas, vapor, or both in a hollow fiber membrane module. The spacers prevent or inhibit channeling and concentration polarization, thereby improving separation performance. Moreover, the spacers promote a uniform flow of the feed mixture while avoiding a severe pressure drop across the hollow fiber membrane module.

### BRIEF DESCRIPTION OF THE DRAWINGS

FIG. 1 is a cross-sectional view of an “inside-out” hollow fiber membrane module.

FIG. 2 is a cross-sectional view of an “outside-in” hollow fiber membrane module.

FIG. 3 is a cross-sectional view of a hollow fiber membrane module with spacers.

FIG. 4A depicts a lumped spacer. FIGS. 4B and 4C are cross-sectional views of the lumped spacer of FIG. 4A with and without a core, respectively.

FIG. 5A depicts a braided spacer with a core. FIG. 5B is a cross-sectional view of the braded spacer of FIG. 5A. FIG. 5C depicts a braided spacer without a core.

FIG. 6A depicts a beaded spacer. FIGS. 6B and 6C are cross-sectional views of the beaded spacer of FIG. 6A.

FIG. 7A depicts a spacer in the form of a wavy fiber or thread. FIG. 7B depicts a cross-sectional view of a wavy hollow fiber spacer. FIG. 7C depicts a cross-sectional view of a wavy thread spacer.

FIG. 8A depicts a spacer in the form of a coiled fiber or thread with a straight core. FIGS. 8B and 8C are cross-sectional views of the spacer of FIG. 8A with a coiled thread and with a coiled hollow fiber, respectively.

FIG. 9A shows hollow fiber membranes and wavy hollow fiber spacers. FIG. 9B shows a fiber bundle formed of the membranes and spacers of FIG. 9A for insertion in a module housing. FIG. 9C shows a hollow fiber membrane module with the fiber bundle of FIG. 9B. FIG. 9D shows an end view of the hollow fiber membrane module of FIG. 9C.

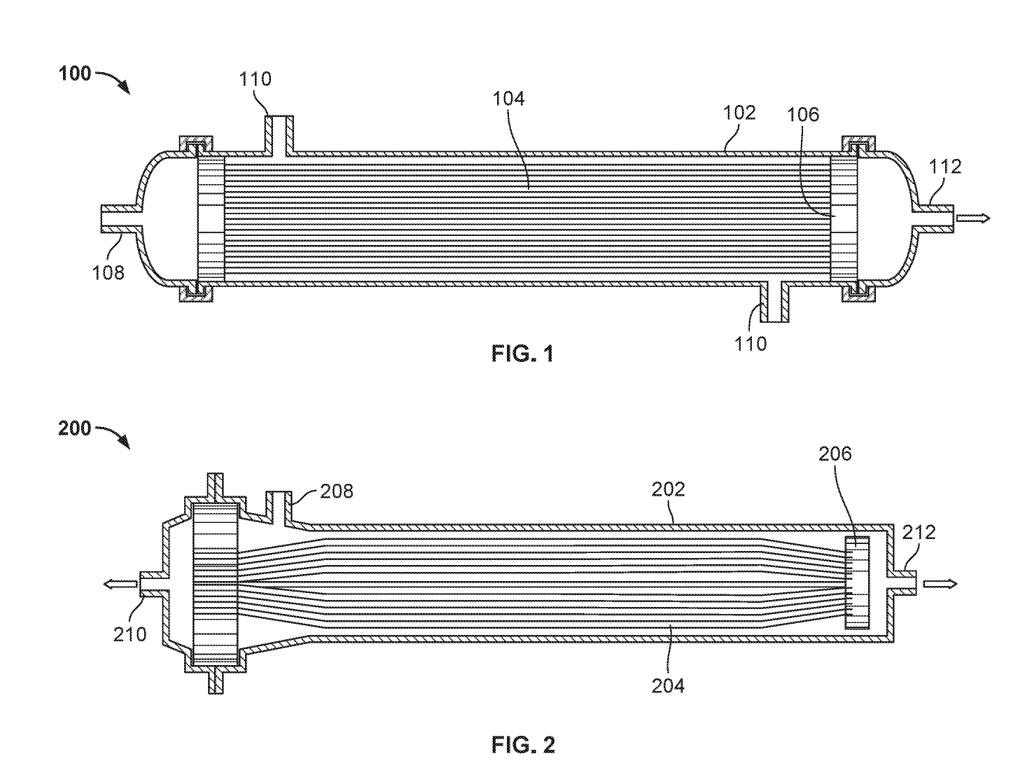

### DETAILED DESCRIPTION

Performance of a hollow fiber membrane module may be improved by reducing channeling and concentration polarization in the module. In “inside-out” module designs, concentration polarization can be reduced by providing more space between hollow membrane fibers, thereby increasing permeate diffusion. With faster permeate diffusion, the concentration gradient (driving force of separation) can be maintained throughout the hollow fiber membrane module. For “outside-in” module designs, the feed channeling and dead zones can be reduced by increasing mixing in the module, thereby increasing the permeation flux.

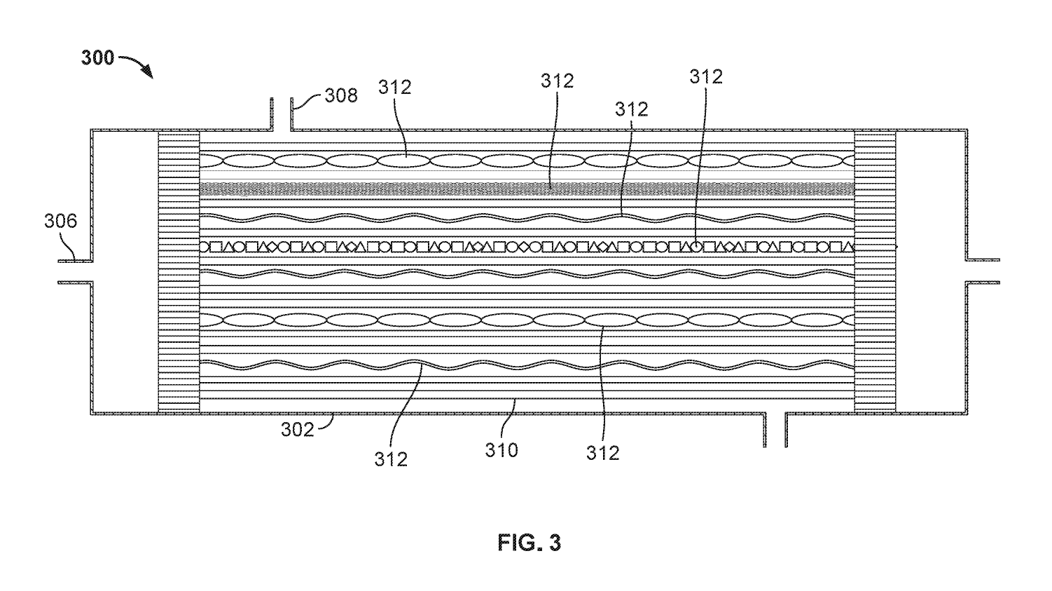

As described herein, hollow fiber membrane modules for gas and/or vapor mixtures advantageously include spacers designed to promote mixing of feed and permeate by reducing concentration polarization and channeling in hollow fiber membrane modules. The spacers increase permeation and separation performance. FIG. 3 depicts hollow fiber membrane module 300 with housing 302 and ports 306, 308. Hollow fiber membrane module 300 may be configured as an “inside-out” or “outside-in” module. Hollow fiber membranes 310 are contained in housing 302. Hollow fiber membranes 310 are elongated and tubular, having substantially straight parallel sides and a circular cross section. That is, each hollow fiber membrane 310 is cylindrical and defines an opening along its length. An inner diameter (ID) and an outer diameter (OD) of hollow fiber membranes 310 are substantially constant along a length of the hollow fiber membrane. An OD of hollow fiber membranes 310 for gas separation is typically in range between 100 microns and 1500 microns, and a ratio of OD to ID is typically in a range of 1.2 to 3.5. A length of hollow fiber membranes 310 for gas and/or vapor separation is typically in a range between 30 centimeters and 2 meters. Hollow fiber membranes 310 may be made of a variety of materials, including polysulfone, polyethersulfone, polyimide, polyetherimide, polyamide, and polydimethylsiloxane.

A multiplicity of elongated spacers 312 are contained in housing 302 and arranged along a length of housing 302, positioned among and in contact with hollow fiber membranes 310. An outer diameter of spacers 312 is typically 20% to 200% of the outer diameter of hollow fiber membranes 310. For spacers 312 having a constant outer diameter, the outer diameter is at least 20% of the outer diameter of hollow fiber membranes 310. Hollow fiber membranes 310 and spacers 312 typically occupy about 40% to about 60% (for example, about 50%) of the interior volume of housing 302, and spacers 312 typically occupy 5% to 50% of the total volume occupied by the hollow fiber membranes. Spacers 312 may be hollow or filled. Filled spacers may include a core made of the same material as an outer portion (the shell) of the spacer or a different material. In some embodiments, an outer surface of each spacer 312 is curved or includes convex regions, concave regions, or both. An outer surface of each spacer 312 along a length of the spacer defines openings or protrusions or curved, discontinuous, or nonlinear portions. Examples of suitable configurations for spacers 312 include lumped spacers, braided spacers, beaded spacers, wavy spacers, and wound spacers. In some embodiments, hollow fiber membrane module 300 includes a multiplicity of spacers having the same configuration, such as only beaded spacers or only braided spacers. In some embodiments, hollow fiber membrane module 300 includes a multiplicity of spacers having two or more different configurations, such as beaded spacers and braided spacers.

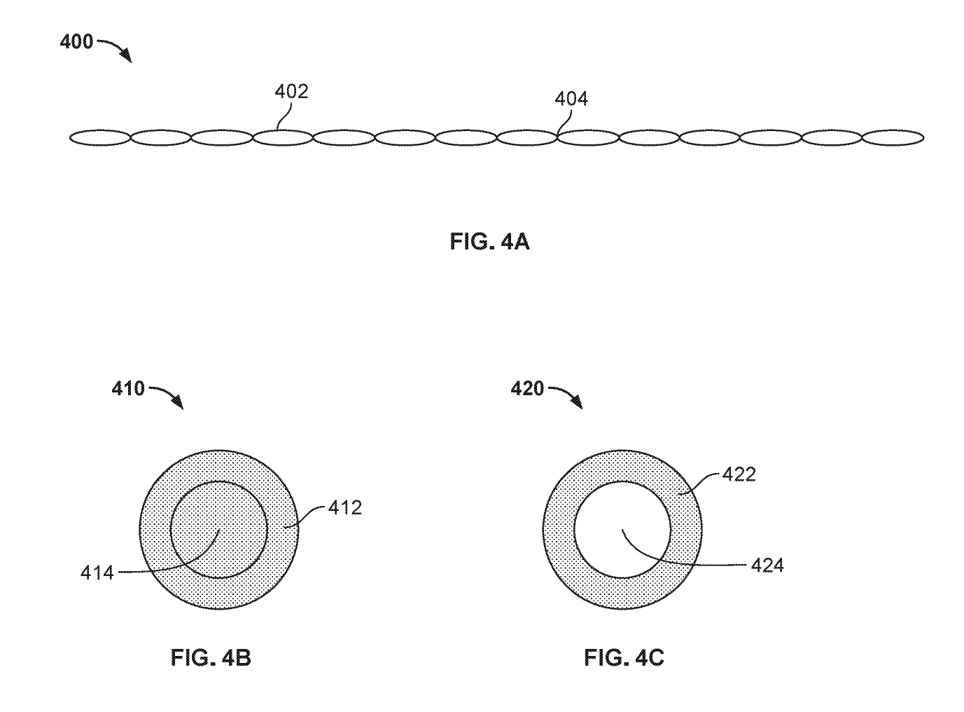

Examples of suitable spacers are depicted in FIGS. 4A, 5A, 6A, 7A, and 8A, and cross-sectional views of these spacers are shown in FIGS. 4B-4C, 5B, 6B, 7B-7C, and 8B-8C, respectively. As used herein, a “fiber spacer” generally refers to a spacer defining an opening along a length of the spacer, and is thus “hollow.” A “thread spacer” generally refers to a spacer with no opening along a length of the spacer, and is thus “solid.” Suitable materials for the spacers include metals, ceramics, glasses, polymers such as polypropylene and polyethylene, or a combination thereof. In some embodiments, spacers are fabricated of the same material as hollow fiber membranes separated by the spacers.

FIG. 4A depicts spacer 400 formed of a lumped fiber or thread. Spacer 400 has shell 402 with indentations or constrictions 404, such that an outer surface of the spacer along a length of the spacer is curved or nonlinear. In some embodiments, spacer 400 has a multiplicity of openings separated by indentations or constrictions 404. FIGS. 4B and 4C are cross-sectional views of different embodiments of spacer 400. FIG. 4B is a cross-sectional view of spacer 410 with first outer surface 412 and second outer surface 414 indicative of the change in outer diameter along the length of the spacer. FIG. 4C is a cross-sectional view of spacer 420 with shell 422. Shell defines opening 424 along a length of spacer 420.

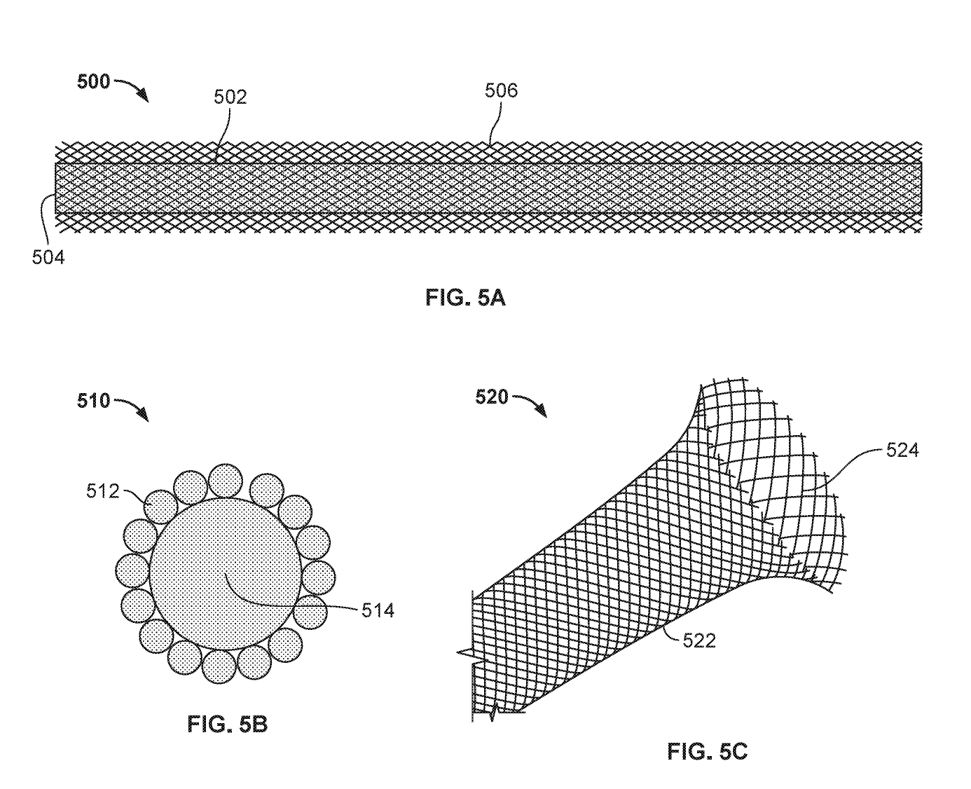

FIG. 5A depicts braided spacer 500 having braided shell 502 and core 504. Core 504 may be formed of the same material as braided shell 502 or a different material. Braided shell 502 is formed of a mesh defining openings 506. In some cases, braided spacer 500 is hollow. That is, braided spacer 500 may define an opening along a length of the spacer. In some embodiments, braided spacer 500 includes shell 502 only. That is, core 504 may be absent. In some embodiments, braided spacer includes shell 502 and core 504. Core 504 may be solid or hollow. FIGS. 5B and 5C are views of different embodiments of spacer 500. FIG. 5B is a cross-sectional view of spacer 510 depicting braided shell 512 and solid core 514. FIG. 5C is a perspective view of an end of spacer 520 with shell 522 and no core. Shell 522 defines opening 524 along a length of spacer 520.

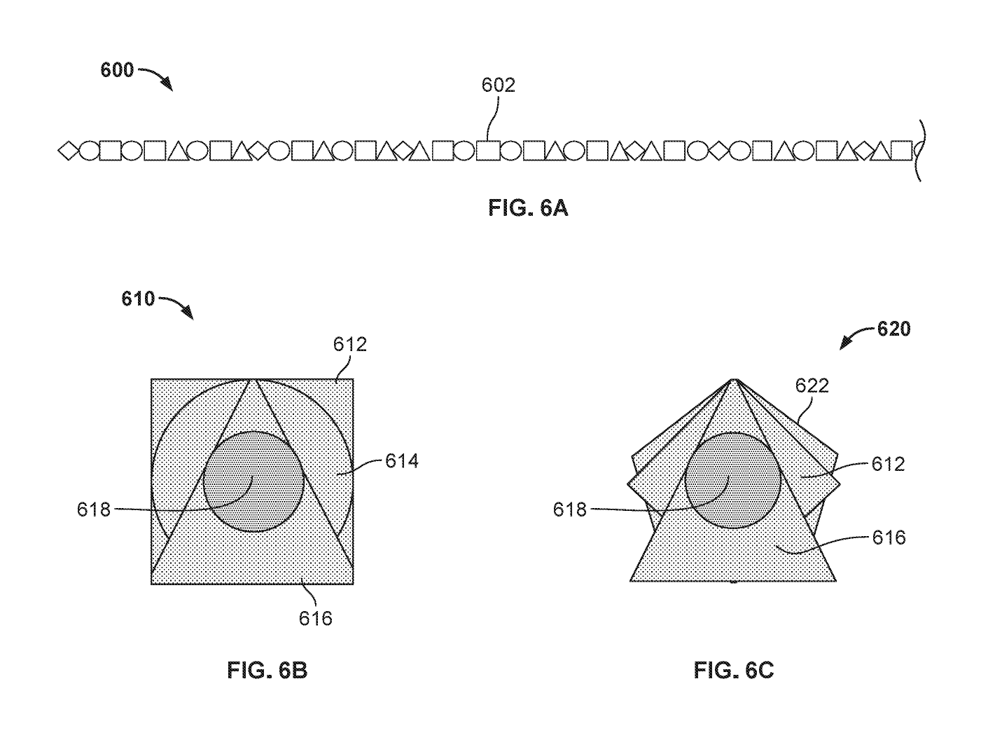

FIG. 6A depicts beaded spacer 600. Spacer 600 is formed of a multiplicity of geometrical shapes 602 coupled together, such that an outer surface of the spacer along the length of the spacer is discontinuous. In some embodiments, geometrical shapes 602 are molded together to form an elongated shape. In some embodiments, geometrical shapes 602 are coupled together along a solid core. In one example, geometrical shapes 602 are strung on a wire or filament. Spacer 600 may include a single solid geometrical shape, or two or more geometrical shapes. Suitable examples of geometrical shapes include spheres, cubes, triangular solids, and double pyramids, as depicted in FIG. 6A. FIGS. 6B and 6C are views of different embodiments of spacer 600. FIG. 6B is a cross-sectional view of spacer 610 with cubes 612, spheres 614, and triangular solids 616 coupled together on solid core 618. Solid core 618 may be formed of the same material as the geometrical solids or a different material. FIG. 6C is a cross-sectional view of spacer 620 with pentagonal solids 622, cubes 612, and triangular solids 616 coupled together and randomly packed on solid core 618. Solid core 618 may be formed of the same material as the geometrical solids or a different material.

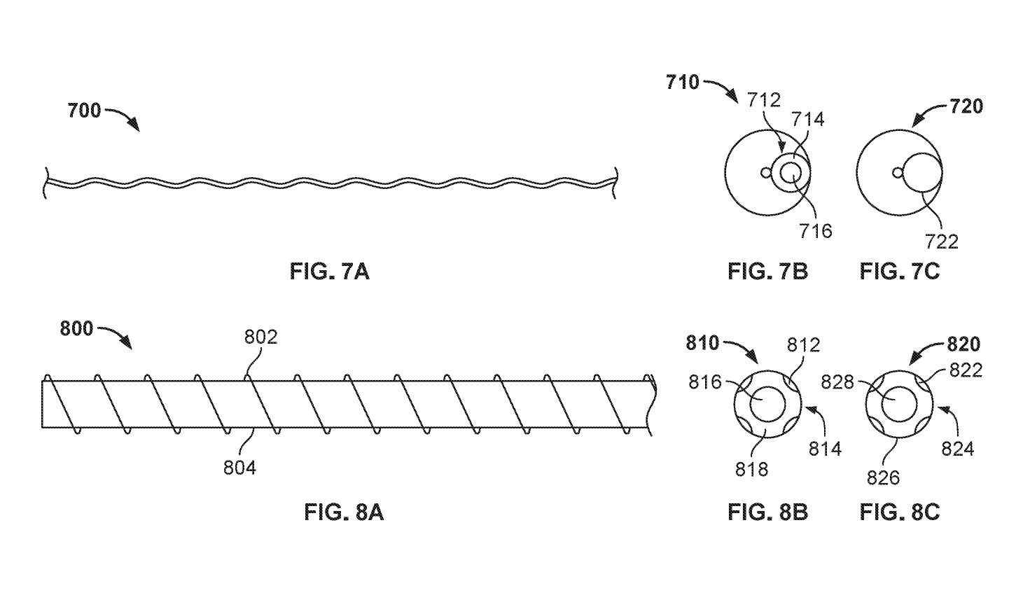

FIG. 7A depicts wavy fiber or thread spacer 700. An outer surface of spacer 700 along the length of the spacer is curved or nonlinear. FIGS. 7B and 7C are cross-sectional views of different embodiments of spacer 700. FIG. 7B is a cross-sectional view of a wavy fiber spacer 710 with hollow fiber 712 including shell 714 defining opening 716. FIG. 7C is a cross-sectional view of a wavy thread spacer 720 with solid thread 722.

FIG. 8A depicts wound spacer 800 having winding 802 around core 804, such that winding 802 forms protrusions from an outer surface of spacer 800 along a length of the spacer. Core 804 is typically a fiber or a thread. Winding 802 may be formed of the same material as or a different material than core 804. In some embodiments, winding 802 is formed of a metal, and core 804 is formed of a polymer. FIGS. 8B and 8C are cross-sectional views of different embodiments of spacer 800. FIG. 8B is a cross-sectional view of spacer 810 with winding 812 about thread 814. As depicted, thread 814 has inner core 816 and outer core 818. Inner core 816 and outer core 818 may be formed of the same material or a different material. In some embodiments, solid core 814 is a single solid material, such as core 514 of spacer 510, depicted in FIG. 5B. FIG. 8C is a cross-sectional view of spacer 820 with winding 822 about hollow fiber 824. Fiber 824 includes shell 826 defining opening 828 along a length of spacer 820.

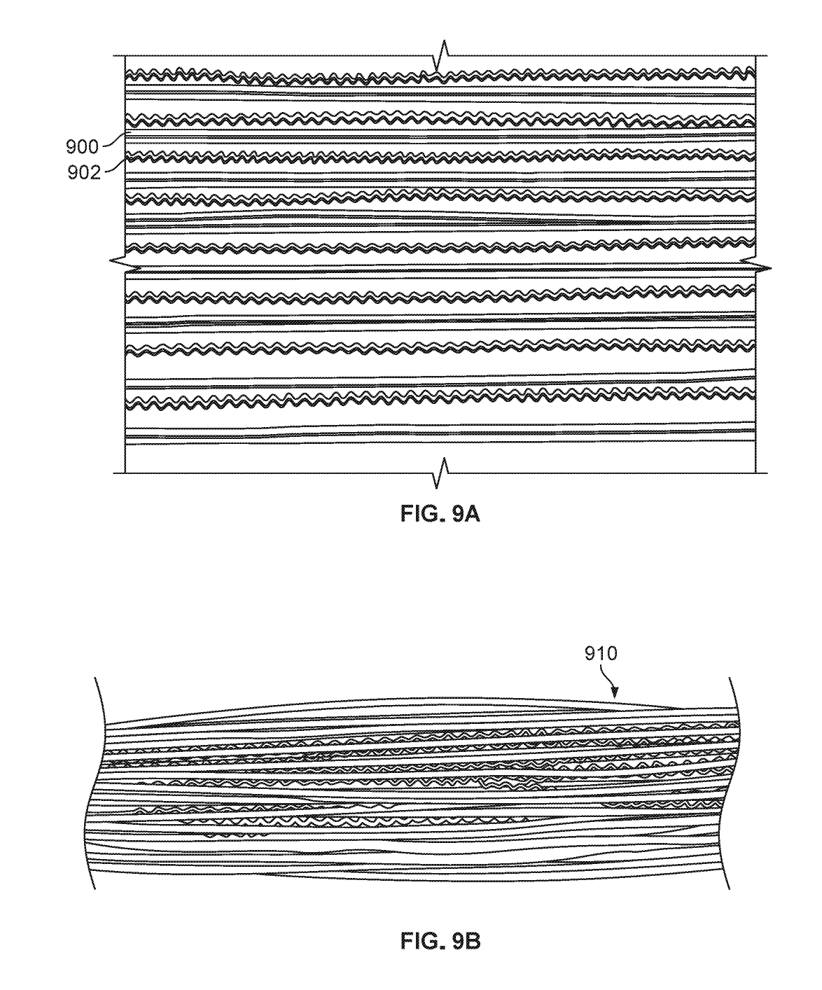

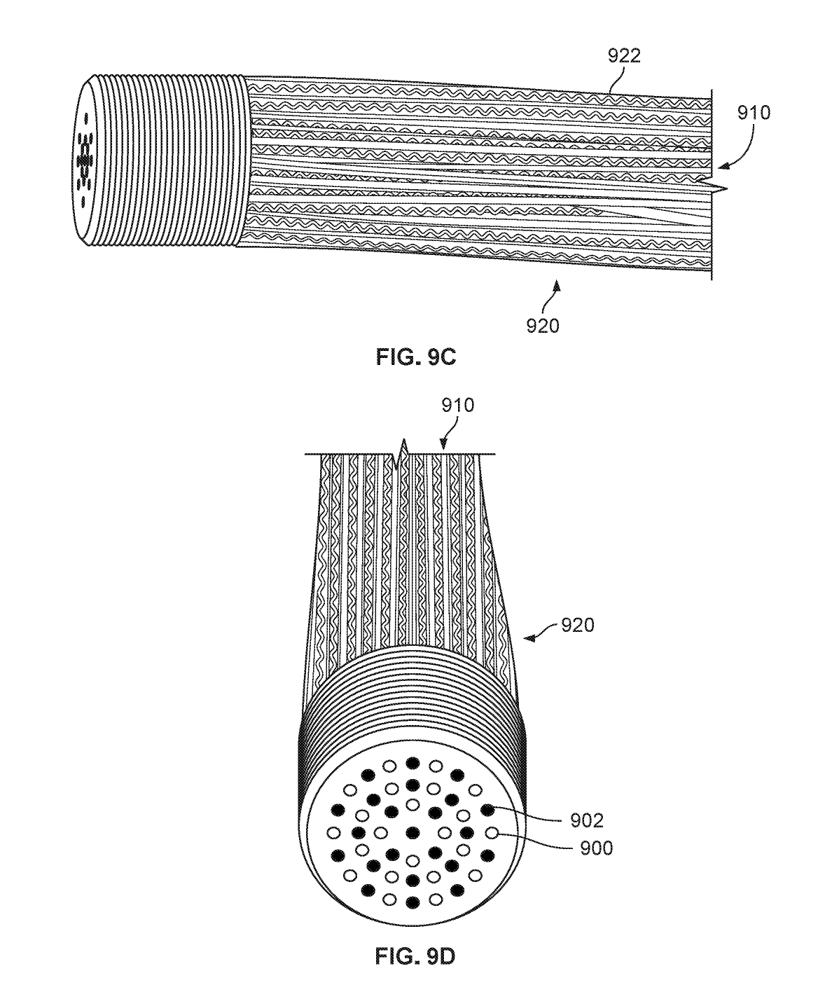

A hollow fiber membrane module may be fabricated by aligning hollow fiber membranes, forming a fiber bundle of the hollow fiber membranes, and inserting the fiber bundle into a hollow fiber membrane module housing. FIG. 9A depicts hollow fiber membranes 900 and elongated spacers 902 aligned prior to formation of a fiber bundle. Spacers 902 are wavy fibers or threads, such as spacers 700. Hollow fiber membranes 900 and spacers 902 are bundled together to form a fiber bundle. FIG. 9B depicts fiber bundle 910 prior to insertion of the fiber bundle into a hollow fiber membrane module housing. FIG. 9C depicts a side view of hollow fiber membrane module 920 with fiber bundle 910 sealed in housing 922. FIG. 9D depicts an end view of hollow fiber membrane module 920, with representative hollow fiber membranes 900 and spacers 902.

What is claimed is:

1. A hollow fiber membrane module comprising:
a housing; and
a fiber bundle contained in the housing and arranged along a length of the housing, wherein the fiber bundle comprises:
hollow fiber membranes, wherein each hollow fiber membrane is cylindrical and defines an opening along its length; and
elongated spacers positioned among and in direct contact with the hollow fiber membranes;
wherein the housing defines:
an inlet for a feed mixture comprising a gas, a vapor, or both;
a first outlet for a permeate of the hollow fiber membranes; and
a second outlet for a retentate of the hollow fiber membranes, and
wherein an outer surface along a length of each elongated spacer defines openings or protrusions or curved, discontinuous, or nonlinear portions.

2. The hollow fiber membrane module of claim 1, wherein an outer diameter of the elongated spacers is 20% to 200% of the outer diameter of the hollow fiber membranes.

3. The hollow fiber membrane module of claim 1, where the hollow fiber membranes and the elongated spacers occupy 40% to 60% of the interior volume of the housing, and the elongated spaces occupy 5% to 50% of the total volume occupied by the hollow fiber membranes.

4. The hollow fiber membrane module of claim 1, wherein the elongated spacers are in the form of lumped fibers.

5. The hollow fiber membrane module of claim 1, wherein the elongated spacers are in the form of lumped threads.

6. The hollow fiber membrane module of claim 5, wherein each elongated spacer defines an opening along the length of the spacer.

7. The hollow fiber membrane module of claim 5, wherein each elongated spacer has a solid core.

8. The hollow fiber membrane module of claim 1, wherein each elongated spacer comprises a braided shell comprising of a mesh defining openings.

9. The hollow fiber membrane module of claim 8, wherein the braided shell is hollow.

10. The hollow fiber membrane module of claim 8, wherein each elongated spacer further comprises a core positioned within the braided shell.

11. The hollow fiber membrane module of claim 10, wherein the core is a solid core.

12. The hollow fiber membrane module of claim 10, wherein the core is tubular.

13. The hollow fiber membrane module of claim 1, wherein each elongated spacer comprises a multiplicity of geometrical shapes coupled together.

14. The hollow fiber membrane module of claim 1, wherein each elongated spacer comprises a curly or wavy fiber.

15. The hollow fiber membrane module of claim 1, wherein each elongated spacer comprises a curly or wavy tube.

16. The hollow fiber membrane module of claim 1, wherein each elongated spacer comprises a core and a winding wound about the core from a first end of the core to a second end of the core.

17. The hollow fiber membrane module of claim 1, wherein the core is a solid core.

18. The hollow fiber membrane module of claim 1, wherein the core is tubular.

19. The hollow fiber membrane module of claim 1, wherein the winding is formed of metal, ceramic, glass, polymer, or a combination thereof.

20. The hollow fiber membrane module of claim 1, wherein the elongated spacers are formed of metal, ceramic, glass, polymer, or a combination thereof.
